(19) United States
(12) Patent Application Publication
(10) Pub. No.: US 2026/0360994 A1
(43) Pub. Date: Nov. 12, 2026

(54) ANTENNA ARRANGEMENT FOR A VEHICLE

(71) Applicant: HELLA GMBH & CO. KGAA, Lippstadt (DE)

(72) Inventors: Tobias Breddermann, Lippstadt (DE); Andreas von Rhein, Salzkotten (DE); Christian Westhues, Hamm (DE)

(21) Appl. No.: 19/120,928

(22) PCT Filed: Oct. 9, 2023
(86) PCT No.: PCT/EP2023/077867

§ 371 Date: Apr. 14, 2025

(30) Foreign Application Priority Data
Oct. 19, 2022 (DE) 10 2022 127 471.3

(51) Int. Cl. H01Q 21/06; H01Q 1/32; H01Q 3/30

(52) U.S. Cl. CPC H01Q 21/061; H01Q 3/30; H01Q 1/3233

(57) ABSTRACT

The invention presented relates to an antenna arrangement for a vehicle. The antenna arrangement includes a plurality of antennas, wherein the plurality of antennas include a plurality of transmitter antennas for emitting beams and a plurality of receiving antennas for receiving beams emitted by respective transmitter antennas. The plurality of transmitter antennas include: a first transmitter antenna, a second transmitter antenna, and a third transmitter antenna. The plurality of receiving antennas include: a first receiving antenna, a second receiving antenna, a third receiving antenna, and a fourth receiving antenna.

### CROSS-REFERENCE TO RELATED APPLICATIONS

This application is the National Stage of International Application No. PCT/EP2023/077867 filed on Oct. 9, 2023, which claims priority to and all advantages of German Patent Application No. 10 2022 127 471.3 filed on Oct. 19, 2022, the disclosures of which are hereby incorporated by reference in their entirety.

### BACKGROUND

The present invention relates to an antenna arrangement, a radar sensor, and a vehicle.

Antenna arrangements with several antennas can be used in a so-called “multiple input multiple output” (MIMO) configuration for the directional radiation of beams by means of so-called “beamforming”, in which the transmission power of individual antennas is increased and/or offset in time compared to other antennas.

MIMO radar applications are also known in the vehicle sector, which are used to detect objects in a vehicle's surroundings.

The radiation pattern of most antennas shows a pattern of “lobes” at different angles, directions in which the radiated signal strength reaches a maximum, separated by “nulls”, i.e. angles at which the radiated signal strength drops to zero.

In a directional antenna, where the aim is to emit radiation waves in one direction, the lobe in that direction is designed to have a greater field strength than the other lobes; this is the “main lobe”. The other lobes are called “side lobes” or sidelobes and usually represent unwanted radiation in unwanted directions.

The longer the antenna is in relation to the radio wavelength, the more lobes its radiation pattern has. With transmitting antennas, excessive sidelobe radiation wastes energy and can interfere with other apparatus. A further disadvantage is that confidential information can be intercepted by unintended recipients. With receiving antennas, side lobes can pick up interference signals and increase the noise level in the receiver.

The power density in the side lobes is generally much lower than that in the main beam. It is generally desirable to minimize the sidelobe level (SLL), which is measured in decibels relative to the peak of the main beam. The main lobe and the side lobes occur both when transmitting and receiving.

Since the far field radiation pattern of an antenna is a Fourier transform of its aperture distribution, most antennas generally have sidelobes.

### SUMMARY

Against this background, it is an object of the present invention to provide an antenna arrangement for a vehicle which requires the smallest possible side lobes.

Thus, according to a first aspect of the present invention, an antenna arrangement for a vehicle is presented.

The antenna arrangement presented comprises a plurality of antennas, wherein the plurality of antennas comprises a plurality of transmitter antennas for emitting beams and a plurality of receiving antennas for receiving beams emitted by respective transmitter antennas.

The plurality of transmitter antennas comprises a first transmitter antenna, a second transmitter antenna and a third transmitter antenna.

The antenna arrangement further comprises a plurality of receiving antennas, wherein the plurality of receiving antennas comprise a first receiving antenna, a second receiving antenna, a third receiving antenna and a fourth receiving antenna. In the context of the invention presented, a lobe is understood to be a progression of values that corresponds to a deflection, i.e. a sharp rise and fall in the values.

The antenna arrangement presented comprises a configuration of three transmitter antennas and four receiving antennas, which are aligned relative to one another or arranged relative to one another on an azimuth plane.

In particular, the antenna arrangement presented is used for transmitting and receiving radar beams, so that objects located in an environment of the antenna arrangement or their orientation relative to the antenna arrangement can be inferred on the basis of a propagation time of the radar beams.

The configuration of the antenna arrangement presented achieves a radiation pattern with particularly small side lobes, which reduces the strength of the side lobes to below 10⁻³ dBi and reduces false detection in the area of the side lobes accordingly.

It may be provided that the plurality of antennas are arranged along an azimuth plane in a grid extending over grid points from 0 to 16, wherein the grid is divided into multiples of an azimuth factor, the azimuth factor corresponding to a value between 0.8 and 2 multiplied by half of a respective wavelength at which the antenna arrangement operates.

A location of the respective antennas of the antenna arrangement presented can be specified particularly precisely in relation to a respective wavelength (lambda) at which the antenna arrangement is operated.

A division of an azimuth plane into a grid with 16 grid points requires a division of the azimuth plane into 16th parts, wherein a part corresponds to a value between 0.8 and 2, multiplied by half of a respective wavelength.

It may be provided that in a first configuration, the first transmitter antenna is arranged at a grid point 0, the second transmitter antenna at a grid point 6 and the third transmitter antenna at a grid point 16, the first receiving antenna at a grid point 0, the second receiving antenna (Rx1) at a grid point 4 or 5, the third receiving antenna (Rx2) at a grid point 7 or 8, and the fourth receiving antenna (Rx3) at a grid point 12.

Experiments have shown that a configuration in which a transmitter antenna is arranged at one extreme point or one end of the azimuth plane and a further transmitter antenna is arranged between the ends and relative to the respective receiving antennas leads to particularly small side lobes. A configuration in which the further transmitter antenna located between the ends is arranged in an area adjacent to two middle receiving antennas at the level of the receiving antennas has proven to be particularly suitable for generating a radiation field with weak or small side lobes.

It may further be provided that, in a second configuration, the first transmitter antenna is arranged at a grid point 0, the second transmitter antenna at a grid point 10 and the third transmitter antenna at a grid point 16, the first receiving antenna at a grid point 0, the second receiving antenna at a grid point 4 or 5, the third receiving antenna at a grid point 7 or 8, and the fourth receiving antenna at a grid point 12.

The second configuration substantially corresponds to a mirror image of the first configuration of the antenna arrangement presented and has also proven to be particularly suitable for generating a radiation field with weak or small side lobes.

It may be provided that the antenna arrangement is a multiple input multiple output (MIMO) arrangement and comprises a controller configured to determine an orientation of the antenna arrangement relative to respective objects in an environment of the antenna arrangement based on beams radiated by the plurality of transmitter antennas and received by the plurality of receiving antennas.

Since the antenna arrangement presented shows particularly small side lobes and a correspondingly low false detection of beams, it is suitable for a particularly precise determination of an orientation of the antenna arrangement or of a respective system comprising the antenna arrangement, relative to respective objects in an environment of the antenna arrangement.

It may further be provided that the control device is configured to carry out beamforming based on a Fourier transform of signals detected by the plurality of antennas.

By means of a so-called “beamforming”, i.e. a procedure for aligning emitted radiation, which is evaluated on the basis of a Fourier transformation, a particularly computationally efficient determination of an alignment of the antenna arrangement relative to respective objects in an environment of the antenna arrangement can be carried out.

It may further be provided that the plurality of transmitter antennas are distributed over a first plurality of elevation planes.

In experiments, transmitter antennas distributed over a height of the antenna arrangement, i.e. an elevation plane of the antenna arrangement, have proven to be particularly advantageous for generating a radiation field with particularly small or weak side lobes.

It may further be provided that the plurality of receiving antennas are distributed over a second plurality of elevation planes.

Receiving antennas distributed over a height of the antenna arrangement, i.e. an elevation plane of the antenna arrangement, have proven in experiments to be particularly advantageous when generating a radiation field with particularly small or weak side lobes. A height or elevation plane in which the receiving antennas are distributed may differ from a height or elevation plane in which the transmitter antennas are arranged.

It may also be provided that the plurality of antennas are radar antennas.

Radar antennas, i.e. antennas configured to emit or receive radar waves, have proven in experiments to be particularly suitable for determining a position of the antenna arrangement relative to objects located in an environment of the antenna arrangement. Furthermore, radar antennas have proven to be particularly suitable for use in road traffic, e.g. for controlling a vehicle.

According to a second aspect, the presented invention relates to a vehicle comprising a possible embodiment of the presented antenna arrangement.

According to a further aspect, the invention relates to a radar sensor with an antenna arrangement as described above.

### BRIEF DESCRIPTION OF THE DRAWINGS

The invention is explained in more detail in the attached drawings. In the figures:

FIG. 1 is a possible configuration of the antenna arrangement presented,

FIG. 2 is a radiation pattern determined by the antenna arrangement as shown in FIG. 2, and

FIG. 3 is a possible design of the vehicle presented.

### DETAILED DESCRIPTION

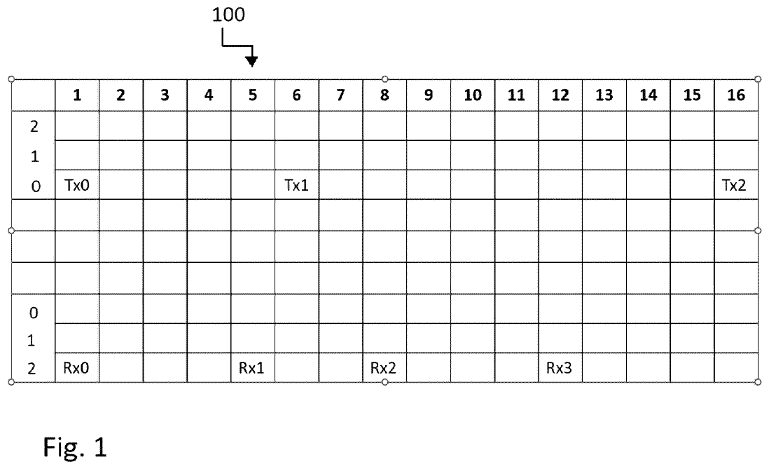

FIG. 1 shows a grid 100 which extends in the longitudinal direction over an azimuth plane of an antenna arrangement and in the transverse direction over elevation planes of the antenna arrangement. Following is marked in the grid 100: a first transmitter antenna (Tx0), a second transmitter antenna (Tx1), a third transmitter antenna (Tx2), a first receiving antenna (Rx0), a second receiving antenna (Rx1), a third receiving antenna (Rx2) and a fourth receiving antenna (Rx3).

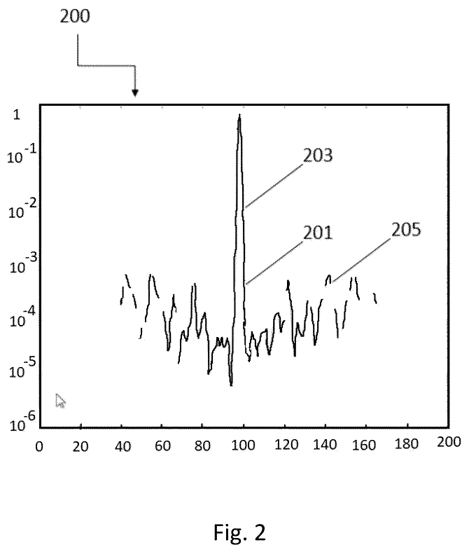

In FIG. 2, a diagram 200 is represented which spans time on its abscissa and a directivity in dBi on its ordinate.

Based on a course 201, it is easy to see that a main lobe 203 strikes significantly higher than the respective side lobes 205, so that the main lobe is particularly reliably recognized as such and false detections by side lobes 205 are minimized.

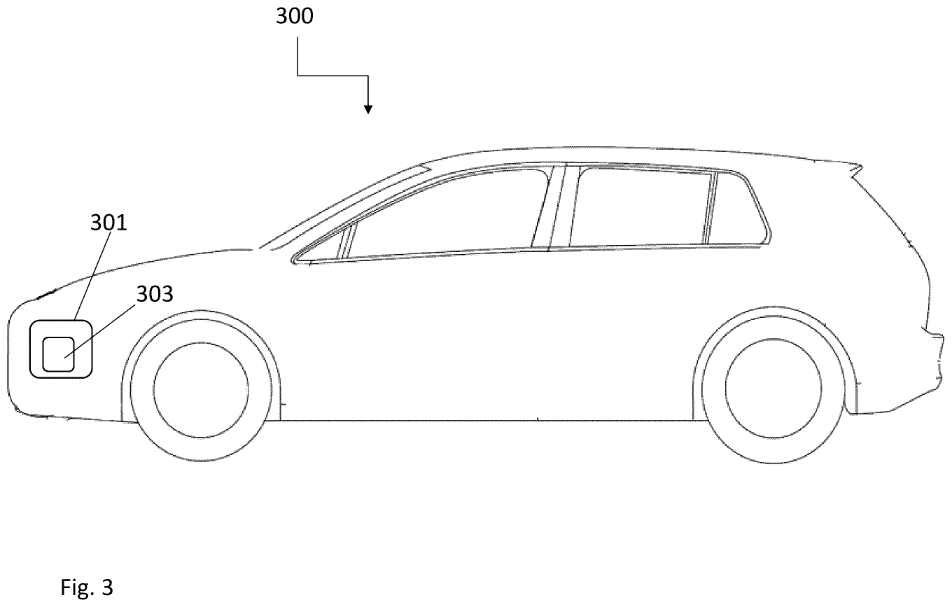

FIG. 3 shows a vehicle 300. The vehicle 300 comprises a distance measuring system 301 with the antenna arrangement 303 according to FIG. 1.

### LIST OF REFERENCE NUMBERS

100 grid
Tx0 first transmitter antenna
Tx1 second transmitter antenna
Tx2 third transmitter antenna
Rx0 first receiving antenna
Rx1 second receiving antenna
Rx2 third receiving antenna
Rx3 fourth receiving antenna
200 diagram
201 course
203 main lobe
205 side lobe
300 vehicle
301 distance measuring system
303 antenna arrangement

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An antenna arrangement for a vehicle, wherein the antenna arrangement comprises a plurality of antennas, the plurality of antennas comprising a plurality of transmitter antennas for transmitting beams and a plurality of receiving antennas for receiving beams emitted by respective transmitter antennas, wherein the plurality of transmitter antennas comprise:
a first transmitter antenna,
a second transmitter antenna,
a third transmitter antenna,
wherein
wherein the plurality of receiving antennas comprise:
a first receiving antenna,
a second receiving antenna,
a third receiving antenna,
a fourth receiving antenna.

2. The antenna arrangement according to claim 1, wherein the plurality of antennas are arranged along an azimuth plane in a grid extending over grid points from 0 to 16, wherein the grid is divided into multiples of an azimuth factor, the azimuth factor corresponding to a value between 0.8 and 2 multiplied by half of a respective wavelength at which the antenna array operates.

3. The antenna arrangement according to claim 2, wherein in a first configuration, the first transmitter antenna is located at a grid point 0, the second transmitter antenna is located at a grid point 6 and the third transmitter antenna is located at a grid point 16, the first receiving antenna is located at a grid point 0, the second receiving antenna is arranged at a grid point 4 or 5, the third receiving antenna is arranged at a grid point 7 or 8, and the fourth receiving antenna is arranged at a grid point 12.

4. The antenna arrangement according to claim 2, wherein in a second configuration, the first transmitter antenna is located at a grid point 0, the second transmitter antenna is located at a grid point 10 and the third transmitter antenna is located at a grid point 16, the first receiving antenna is located at a grid point 0, the second receiving antenna is arranged at a grid point 4 or 5, the third receiving antenna is arranged at a grid point 7 or 8 and the fourth receiving antenna is arranged at a grid point 12.

5. The antenna arrangement according to claim 1, wherein the antenna arrangement is a multiple input multiple output (MIMO) arrangement and comprises a control device which is configured to determine an orientation of the antenna arrangement relative to respective objects in an environment of the antenna arrangement on the basis of beams radiated by the plurality of transmitter antennas and received by the plurality of receiving antennas.

6. The antenna arrangement according to claim 5, wherein the control device is configured to carry out beamforming based on a Fourier transform of signals detected by the plurality of antennas.

7. The antenna arrangement according to claim 1, wherein the plurality of transmitter antennas are arranged over a first plurality of elevation planes.

8. The antenna arrangement according to claim 1, wherein the plurality of receiving antennas are distributed over a second plurality of elevation planes.

9. The antenna arrangement according to claim 1, wherein the plurality of antennas are radar antennas.

10. A radar sensor comprising an the antenna arrangement according to claim 1.

11. A vehicle, wherein the vehicle comprises the antenna arrangement according to claim 1.
